(19) United States
(12) Patent Application Publication
(10) Pub. No.: US 2014/0067207 A1
(43) Pub. Date: Mar. 6, 2014

(54) SMART PARKING ASSIST SYSTEM OF VEHICLE AND CONTROL METHOD THEREOF

(71) Applicant: MANDO CORPORATION, Pyeongtaek-si (KR)

(72) Inventor: Tae Bong NOH, Yongin-si (KR)

(73) Assignee: MANDO CORPORATION, Pyeongtaek-si (KR)

(21) Appl. No.: 14/020,763

(22) Filed: Sep. 6, 2013

(30) Foreign Application Priority Data
Sep. 6, 2012 (KR) 10-2012-0098539

(51) Int. Cl. G08G 1/16

(52) U.S. Cl. CPC G08G 1/168
USPC 701/41; 701/1

(57) ABSTRACT

Disclosed herein are a smart parking assist system and a control method thereof in which a plurality of parking modes are prepared according to driving skill levels of drivers so as to differently set the size of a margin considered in recognition of a parking space or setting of a parking path and to prevent deviation of a final parking position due to driving skill level differences among drivers. The smart parking assist system includes an input unit receiving selection of one of parking modes according to driving skill levels, from a user, a parking mode switching unit, when one of parking modes according to driving skill levels is input through the interface, switching the parking mode of the vehicle to the input parking mode, and a margin set unit to set margins to parameters regarding parking space recognition, parking path setting, and parking control of the vehicle according to the switched parking mode.

### CROSS-REFERENCE TO RELATED APPLICATION

This application claims the benefit of Korean Patent Application No. 2012-0098539, filed on Sep. 6, 2012 in the Korean Intellectual Property Office, the disclosure of which is incorporated herein by reference.

### BACKGROUND

1. Field

Embodiments of the present invention relate to a smart parking assist system which automatically controls steering of a vehicle so as to drive the vehicle to a parking space and a control method thereof.

2. Description of the Related Art

In general, a vehicle driver drives a vehicle while visually confirming an obstacle in the rear of the vehicle or at the side of the vehicle using side mirrors or a room mirror mounted in the vehicle during parking.

However, a dead angle zone which a driver does not recognize exists at the rear corner part of the vehicle and, although the driver recognizes an obstacle, if the driver does not accurately understand the length or width of the vehicle, the driver does not recognize a distance between the vehicle and the obstacle and thus, the vehicle may contact the obstacle.

In order to solve such a problem, a parking assist system (PAS) including sensors mounted at the front and rear parts of a vehicle and assisting a driver in recognizing the distance from an obstacle through an alarm sound has been introduced. Further, a smart parking assist system (SPAS) recognizing a parking space, automatically generating a parking path, and automatically controlling a steering wheel to allow a driver to automatically park a vehicle without operating the steering wheel has been introduced.

Even if the SPAS automatically steering a vehicle is used, a driver needs to directly operate gear transmission or braking or deceleration of the vehicle, and at this time, deviation of a final parking position occurs according to the driving skill level of a driver.

### SUMMARY

Therefore, it is an aspect of the present invention to provide a parking assist system and a control method thereof in which a plurality of parking modes are prepared according to driving skill levels of drivers so as to differently set the size of a margin considered in recognition of a parking space or setting of a parking path and to prevent deviation of a final parking position due to driving skill level differences among drivers.

Additional aspects of the invention will be set forth in part in the description which follows and, in part, will be obvious from the description, or may be learned by practice of the invention.

In accordance with one aspect of the present invention, a smart parking assist system of a vehicle having an interface receiving instructions from a user includes a parking mode switching unit, when one of parking modes according to driving skill levels is input through the interface, switching the parking mode of the vehicle to the input parking mode, and a margin set unit to set margins of parameters regarding parking space recognition, parking path setting, and parking control of the vehicle according to the switched parking mode.

The smart parking assist system may further include a parking space recognition unit recognizing a parking space where the vehicle may be parked by sensing an object around the vehicle.

The margin set unit may set a margin of the minimum parking space where the vehicle may be parked, recognized by the parking space recognition unit, based on the switched parking mode.

The smart parking assist system may further include a path set unit to set a parking path to park the vehicle in the parking space recognized by the parking space recognition unit.

The margin set unit may set a collision margin between the vehicle and the object around the vehicle based on the switched parking mode, when the path set unit sets the parking path.

The margin set unit may set a margin of a gear transmission guide message output time based on the switched parking mode.

The margin set unit may decrease the sizes of the margins as the switched parking mode corresponds to a higher driving skill level.

The parking modes may include a beginner mode including at least one level and an expert mode including at least one level.

In accordance with another aspect of the present invention, a control method of a smart parking assist system assisting parking of a vehicle includes receiving selection of one of parking modes according to driving skill levels, from a user, switching the parking mode of the vehicle to the input parking mode, and setting margins regarding parking space recognition, parking path setting, and parking control of the vehicle according to the switched parking mode.

The control method may include recognizing a parking space where the vehicle may be parked by sensing an object around the vehicle.

The setting of the margins may include setting a margin of the minimum parking space where the vehicle may be parked, recognized by the parking space recognition unit, based on the switched parking mode.

The control method may further include setting a parking path to park the vehicle in the parking space recognized by the parking space recognition unit.

The setting of the margins may include setting a margin of a gear transmission guide message output time based on the switched parking mode during setting of the parking path.

The setting of the margins may include setting a collision margin between the vehicle and the object around the vehicle, used in setting a rotation angle of the vehicle or a forward/reverse gear transmission time, during setting of the parking path.

In the setting of the margins, the sizes of the margins may be decreased as the switched parking mode corresponds to a higher driving skill level.

The parking modes may include a beginner mode including at least one level and an expert mode including at least one level.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a control block diagram of a smart parking assist system in accordance with one embodiment of the present invention;

FIG. 2 is a view exemplarily illustrating an interface outputting an image to guide selection of a parking mode;

FIG. 3 is a view illustrating that a vehicle provided with the smart parking assist system in accordance with the embodiment of the present invention searches for a parking space;

FIG. 4 is a view illustrating movement of a vehicle along a parking path set by a path set unit in accordance with one embodiment of the present invention;

FIG. 5 is a view illustrating setting of a rotation angle and forward/backward driving paths in consideration of a collision risk between a vehicle and an obstacle during control of the vehicle along the set parking path; and

FIG. 6 is a flowchart illustrating a control method of a smart parking assist system in accordance with one embodiment of the present invention.

### DETAILED DESCRIPTION

Reference will now be made in detail to the embodiments of the present invention, examples of which are illustrated in the accompanying drawings, wherein like reference numerals refer to like elements throughout.

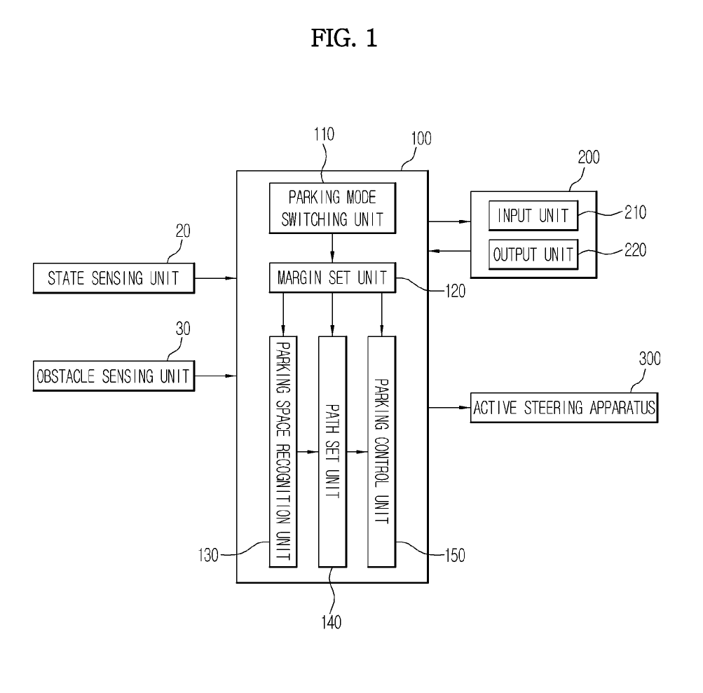

FIG. 1 is a control block diagram of a smart parking assist system in accordance with one embodiment of the present invention.

With reference to FIG. 1, a smart parking assist system 100 in accordance with one embodiment of the present invention includes a parking mode switching unit 110 switching parking modes according to an input parking mode when selection of the parking mode is input to the parking mode switching unit 110 through an interface 200, a margin set unit 120 setting the sizes of margins according to the switched parking mode, a parking space recognition unit 130 recognizing a parking space based on the set sizes of the margins, a path set unit 140 setting a parking path to park a vehicle in the recognized parking space based on the sizes of the margins, set by the margin set unit 120, and a parking control unit 150 driving the vehicle according to the set path.

The smart parking assist system 100 assists parking due to automatic steering based on an object around the vehicle and a distance to the object, sensed by an obstacle sensing unit 20, and the current state of the vehicle sensed by a state sensing unit 30.

The obstacle sensing unit 20 recognizes an obstacle adjacent to the vehicle and senses a distance between the obstacle and the vehicle, and may employ an ultrasonic sensor or a vision sensor, such as a camera. The ultrasonic sensor or the vision sensor may be mounted at the front end, the rear end, or the side surface of the vehicle, but is not limited thereto. That is, the obstacle sensing unit 20 may be mounted at any position of the vehicle which may sense an area necessary for parking space recognition or parking path control.

The state sensing unit 30 senses the current state of the vehicle, and may determine the next motion based on the current state of the vehicle to move the vehicle according to the parking path set by the path set unit 140. The state sensing unit 30 may include at least one of an axle angle sensor to sense an axle angle, a steering angle sensor to sense the steering angle of the vehicle, a gear position sensor to sense the position of a gear, a wheel speed sensor to sense a wheel speed of the vehicle, and a vehicle speed sensor to sense a vehicle speed.

Sensor signals sensed by the obstacle sensing unit 20 and the state sensing unit 30 are transmitted to the smart parking assist system 100, and are used in parking space recognition, path setting, and path control.

An active steering apparatus 300 is connected with the smart parking assist system 100 and actively controls steering of the vehicle under control of the smart parking assist system 100. The active steering apparatus 300 may control steering of the vehicle without operation of a steering wheel by a driver. An electronic power steering (EPS) apparatus, a motor driven power steering (MDPS) apparatus, or an active front steering (AFS) apparatus may be applied to the active steering apparatus 200, and the smart parking assist system 100 in accordance with this embodiment may be connected to various steering apparatuses which may actively control steering of the vehicle in addition to the above-described steering apparatuses.

The interface 200 is generally referred to as a human machine interface (HMI), and includes an input unit 210 receiving instructions to select a parking mode, from a driver. The input unit 210 may receive instructions to select On/Off of the smart parking assist system 100 and instructions to select right angled parking or parallel parking during parking due to automatic steering.

Further, the interface 200 includes an output unit 220 outputting an image to guide selection of a parking mode or to visually or audibly output a guide message to control the path of the vehicle.

The output unit 220 may include a speaker outputting sound or a display unit visually outputting an image, and the input unit 210 may be formed in a switch type or may be a touch panel if the display unit is a touchscreen. Further, if the HMI may perform voice recognition, the input unit 210 may be a microphone receiving the voice of a driver. The configuration of the interface 200 is not limited thereto, and may be formed in various types.

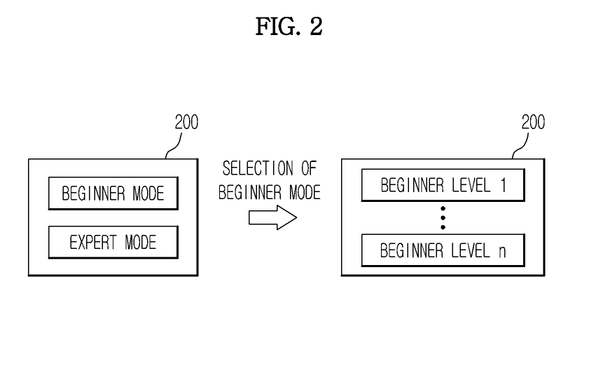

FIG. 2 is a view exemplarily illustrating the interface outputting an image to guide selection of a parking mode. The interface 200 of FIG. 2 is implemented as a touchscreen, and may perform functions of both an output unit and an input unit.

With reference to FIG. 2, the interface 200 may display an image to select one of a beginner mode and an expert mode, and a driver selects a mode corresponding to his/her own driving skill level from the two modes. If the driver is a beginner who is not skilled in driving, the driver selects the beginner mode, and the interface 200 may divide the beginner mode into level 1 to level n (n1) and output these levels 1 to n. For example, level 1 of the beginner mode may be a level corresponding to a driver having the lowest driving skill in the beginner mode, and level n of the beginner mode may be a level corresponding to a driver having the highest driving skill in the beginner mode. Otherwise, the reverse is also possible.

The driver may select a level corresponding to his/her own driving skill level from level 1 to level n of the beginner mode. When the level corresponding to the driver driving skill level is selected by the driver, a signal corresponding to the selected level is transmitted to the parking mode switching unit.

Although FIG. 2 illustrates two parking modes i.e., a beginner mode and an expert mode, according to driving skill levels, embodiments of the present invention are not limited thereto. That is, three parking modes, i.e., a beginner mode, an expert mode, and a general mode, may be prepared.

The parking mode switching unit 110 switches the parking mode of the parking assistance system 100 to a parking mode input through the interface 200. Here, the switched parking mode is a parking mode according to driving skill levels, and may be a parking mode regarding parallel parking/right angled parking.

When the parking mode switching unit 110 performs parking mode switching, the margin set unit 120 sets the size of a margin regarding parking space recognition or parking path setting of the vehicle according to the switched parking mode.

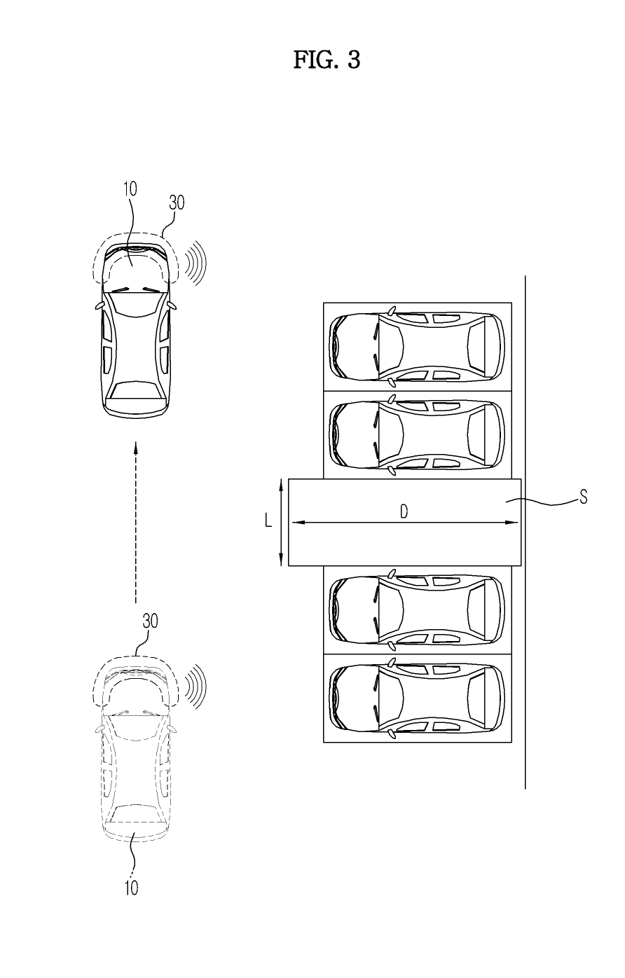

Hereinafter, with reference to FIGS. 3 to 5, detailed operations of the parking space recognition unit 130, the path set unit 140, and the parking control unit 150 will be described.

FIG. 3 is a view illustrating that a vehicle 10 provided with the smart parking assist system in accordance with the embodiment of the present invention searches for a parking space.

With reference to FIG. 3, the parking space recognition unit 130 searches for a parking space based on a sensed signal of the obstacle sensing unit. For example, the parking space recognition unit 130 may measure the size of a space present at the side of the vehicle 10, i.e., the depth D and the width L of the space, using a time taken for ultrasonic waves radiated from an ultrasonic sensor mounted on the side surface of the vehicle to return to the ultrasonic sensor.

The parking space recognition unit 130 sets the minimum parking space where the vehicle may park in consideration of the size of the vehicle 10, and a margin is applied to the minimum parking space in consideration of an error of the searched parking space. Therefore, if the size of the space measured by the obstacle sensing unit is equal to or greater than a size acquired by applying the margin to the minimum parking space, the parking space recognition unit 130 recognizes the measured space as a parking space S.

In general, a skilled driver may park a vehicle even in a relatively narrow space, as compared to an unskilled driver. On the other hand, an unskilled driver may have difficulty parking a vehicle in a narrow space.

Therefore, the margin set unit 120 applies different sizes of a margin to the minimum parking space according to driving skill levels of drivers. For example, if the switched parking mode is the beginner mode, the minimum parking space margin may be set to +1.0 m, if the switched parking mode is the general mode, the minimum parking space margin may be set to +0.8 m, and if the switched parking mode is the expert mode, the minimum parking space margin may be set to +0.6 m. In this case, if the minimum parking space is set to have a length of 4 m and a width of 2 m and the searched parking space has a length of 5 m and a width of 2.7 m, the minimum parking space is not recognized as the parking space S in the beginner mode and the general mode, but is recognized as the parking space S in the expert mode.

The path set unit 140 sets a parking path to move the vehicle 10 to the parking space recognized by the parking space recognition unit 130, and in more detail, calculates coordinates of a parking target point of the vehicle 10 using coordinates of a parking start point, coordinates of two corners of the entrance of the parking space S, and the width and the depth of the parking space S. Then, the path set unit 140 sets a path to move the vehicle 10 from the coordinates of the parking start point to the coordinates of the parking target point.

The parking control unit 150 calculates and sets a steering angle to move the vehicle 10 according to the path set by the path set unit 140, and transmits a control signal to move the vehicle 10 according to the set steering angle to the active steering apparatus or outputs a guidance message to shift gears or to decelerate/brake the vehicle 10 according to the set path through the interface 200.

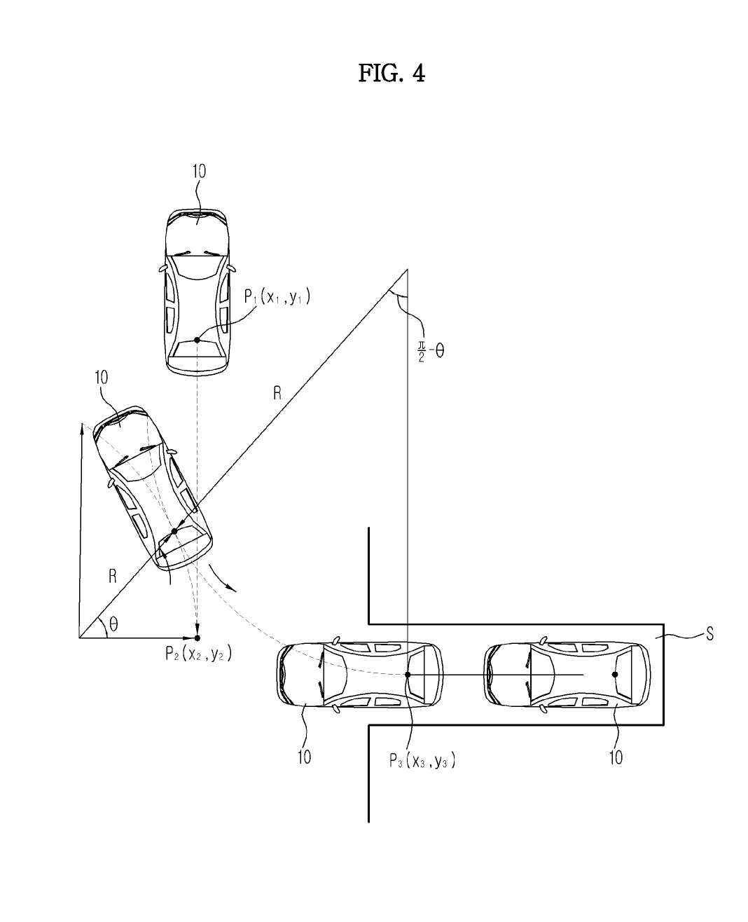

FIG. 4 is a view illustrating movement of a vehicle 10 along a parking path set by the path set unit 140 in accordance with one embodiment of the present invention. In this embodiment, right angled parking is performed.

With reference to FIG. 4, in order to perform right angled parking, a driver drives the vehicle 10 backward to a backward driving point P₂(x₂, y₂) from the position of the parking start point P₁(x₁, y₁) in a direction opposite to a forward driving direction, and then rotates the vehicle 10 by a forward rotation angle (θ) according to a steering angle set by the path control unit and a rotation radius R corresponding to the steering angle while driving the vehicle 10 forward at the backward driving point P₂(x₂, y₂) and. At this point, the driver rotates the vehicle 10 by a backward rotation angle (π/2−θ) according to a steering angle in the opposite direction of the forward rotation angle and a rotation radius R corresponding to the steering angle while driving the vehicle 10 backward and thus, the vehicle 10 reaches the parking target point P₃(x₃, y₃). Thereafter, the driver properly drives the vehicle backward in consideration of the depth of the parking space.

Here, shift between a reverse gear and a forward gear, i.e., gear transmission, is performed directly by the driver according to the guide message outputted through the interface 200. Since a gear transmission time may vary according to driver skill levels, the margin set unit 120 may differently set a gear transmission guide message output time. For example, if the parking mode is the beginner mode, the gear transmission guide message may be output at a point preceding the point where forward/reverse gear transmission is performed by 0.4 m, if the parking mode is the general mode, the gear transmission guide message may be output at a point preceding the point where forward/reverse gear transmission is performed by 0.3 m, and if the parking mode is the expert mode, the gear transmission guide message may be output at a point preceding the point where forward/reverse gear transmission is performed by 0.2 m.

This is only one example, various margins may be applied to the gear transmission guide message output time according to parking modes.

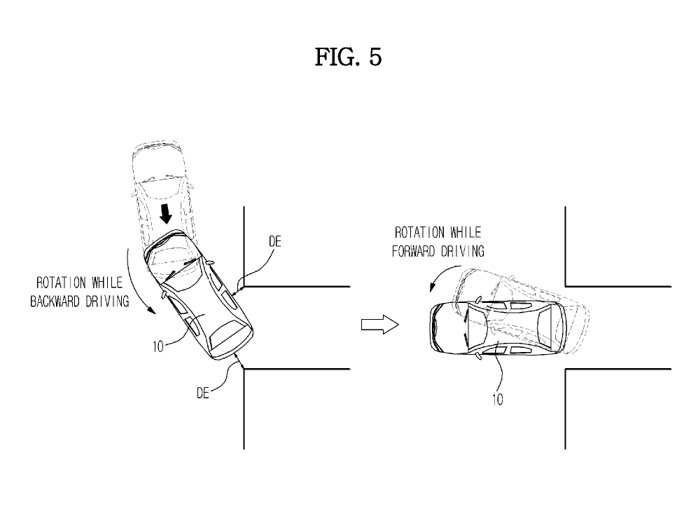

When the path set unit 140 sets the parking path, a collision margin with an obstacle around the vehicle is considered. FIG. 5 is a view illustrating setting of a rotation angle and forward/backward driving paths in consideration of a collision risk between the vehicle and an obstacle during control of the vehicle along the set parking path.

As shown in FIG. 5, the path set unit 140 sets a rotation angle in consideration of a collision margin so that the left and right side surfaces of the rear end of the vehicle 100 do not collide with an obstacle around the vehicle 10 when the vehicle 10 is rotated while backward driving. Further, if parking of the vehicle 10 is not completed by performing rotation of the vehicle while backward driving once, the vehicle 10 is rotated while forward driving. Therefore, the path set unit 140 sets a rotation angle while forward driving and a rotation time while forward driving in consideration of a collision margin.

Here, the margin set unit 120 differently sets a collision margin with the obstacle according to the switched parking mode. For example, if the parking mode is the beginner mode, the collision margin may be set to 0.8 m, if the parking mode is the general mode, the collision margin may be set to 0.6 m, and if the parking mode is the expert mode, the collision margin may be set to 0.4 m.

As the collision margin increases, the number of forward/backward driving steps increases. With reference to FIG. 5, if a distance (DE) between the vehicle and an obstacle is 0.8 m, this situation is regarded as a collision risk and a path is set so that the vehicle 10 is rotated again while forward driving if the parking mode is the beginner mode, but rotation of the vehicle 10 while backward driving is continuously carried out if the parking mode is the general mode or the expert mode.

The above-described margin values are only one example, and various margin values may be applied.

The above-described operation of the margin set unit 120 with reference to FIGS. 3 to 5 is only one example, and the margin set unit 120 may set various margin values according to parking modes in any stage of a parking control method of the smart parking assist system.

Further, the margin set unit 120 may not be a unit separated from the path set unit 140, the parking space recognition unit 130, and the parking control unit 150. That is, the path set unit 140, the parking space recognition unit 130, and the parking control unit 150 may perform the above-described operation of the margin set unit 120.

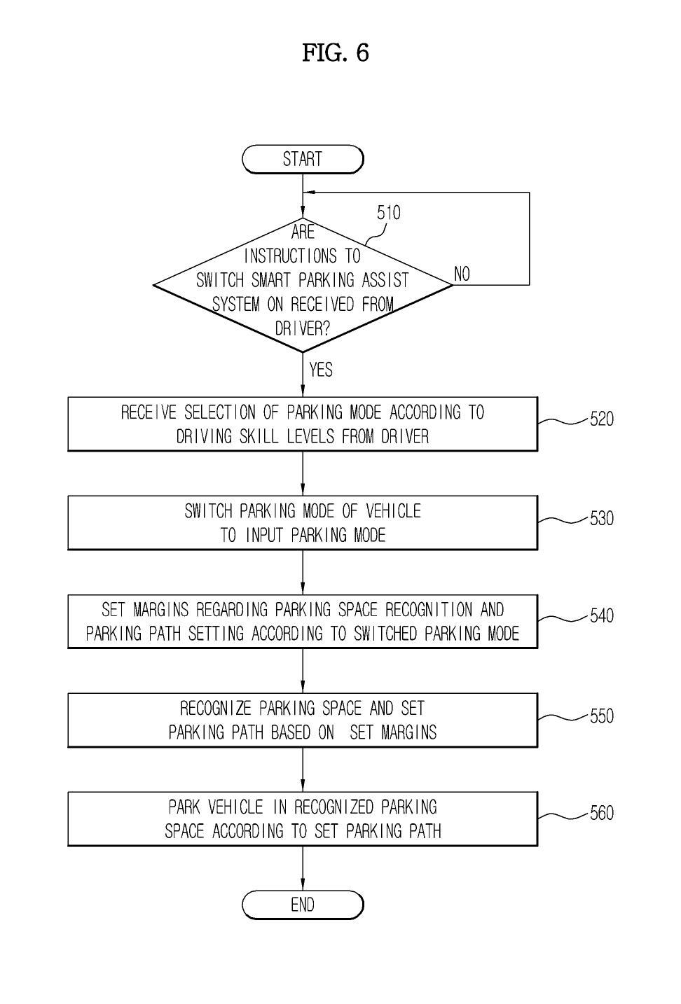

FIG. 6 is a flowchart illustrating a control method of a smart parking assist system in accordance with one embodiment of the present invention.

With reference to FIG. 6, instructions to switch the smart parking assist system on are input to the smart parking assist system by a driver (Operation 510). Here, instructions regarding selection of one of right angled parking and parallel parking may be input to the smart parking assist system.

Thereafter, selection of a parking mode according to a driving skill level of the driver is input to the smart parking assist system by the driver (Operation 520). There may be various parking modes according to driving skill levels. For example, the parking modes may include a beginner mode, a general mode, and an expert mode.

Thereafter, the parking mode of a vehicle is switched to the input parking mode (Operation 530).

Thereafter, margins regarding parking space recognition, parking path setting, and parking control of the vehicle are set according to the switched parking mode (Operation 540), a parking space is recognized and a parking path is set based on the set margins (Operation 550), and parking of the vehicle in the recognized parking space according to the set parking path is controlled (Operation 560). Control of parking of the vehicle includes automatically steering the vehicle through the active steering apparatus and outputting a guide message regarding gear transmission or vehicle deceleration/braking to allow a driver to perform gear shift and to step on a brake pedal.

In more detail, according to the switched parking mode, a margin of the minimum parking space where the vehicle may be parked may be differently set, a margin of the gear transmission guide message output time during parking control may be differently set, and a collision margin with an obstacle around the vehicle may be differently set. These margins have been described in detail in the above description of the smart parking assist system, and a detailed description thereof will thus be omitted.

In the above-described smart parking assist system and the control method thereof in accordance with this embodiment, various margins considered when a parking space is recognized or a parking path is set, are differently set according to driving skill levels of drivers so that a driver having low driving skill may safely park a vehicle and a driver having high driving skill may rapidly park a vehicle through omission of unnecessary control steps.

As is apparent from the above description, in a smart parking assist system and a control method thereof in accordance with one embodiment of the present invention, a plurality of parking modes are prepared according to driving skill levels of drivers so as to differently set the size of a margin considered in recognition of a parking space or setting of a parking path and to prevent deviation of a final parking position due to driving skill level differences among drivers.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A smart parking assist system of a vehicle having an interface receiving instructions from a user, the smart parking assist system comprising:
a parking mode switching unit, when one of parking modes according to driving skill levels is input through the interface, switching the parking mode of the vehicle to the input parking mode; and
a margin set unit to set margins of parameters regarding parking space recognition, parking path setting, and parking control of the vehicle according to the switched parking mode.

2. The smart parking assist system according to claim 1, further comprising a parking space recognition unit recognizing a parking space where the vehicle may be parked by sensing an object around the vehicle.

3. The smart parking assist system according to claim 2, wherein the margin set unit sets a margin of the minimum parking space where the vehicle may be parked, recognized by the parking space recognition unit, based on the switched parking mode.

4. The smart parking assist system according to claim 2, further comprising a path set unit to set a parking path to park the vehicle in the parking space recognized by the parking space recognition unit.

5. The smart parking assist system according to claim 4, wherein the margin set unit sets a collision margin between the vehicle and the object around the vehicle based on the switched parking mode, when the path set unit sets the parking path.

6. The smart parking assist system according to claim 4, wherein the margin set unit sets a margin of a gear transmission guide message output time based on the switched parking mode.

7. The smart parking assist system according to claim 1, wherein the margin set unit decreases the sizes of the margins as the switched parking mode corresponds to a higher driving skill level.

8. The smart parking assist system according to claim 1, wherein the parking modes include a beginner mode including at least one level and an expert mode including at least one level.

9. A control method of a smart parking assist system assisting parking of a vehicle comprising:
receiving selection of one of parking modes according to driving skill levels, from a user;
switching the parking mode of the vehicle to the input parking mode; and
setting margins regarding parking space recognition, parking path setting, and parking control of the vehicle according to the switched parking mode.

10. The control method according to claim 9, further comprising recognizing a parking space where the vehicle may be parked by sensing an object around the vehicle.

11. The control method according to claim 10, wherein the setting of the margins includes setting a margin of the minimum parking space where the vehicle may be parked, recognized by the parking space recognition unit, based on the switched parking mode.

12. The control method according to claim 10, further comprising setting a parking path to park the vehicle in the parking space recognized by the parking space recognition unit.

13. The control method according to claim 12, wherein the setting of the margins includes setting a margin of a gear transmission guide message output time based on the switched parking mode during setting of the parking path.

14. The control method according to claim 12, wherein the setting of the margins includes setting a collision margin between the vehicle and the object around the vehicle, used in setting a rotation angle of the vehicle or a forward/reverse gear transmission time, during setting of the parking path.

15. The control method according to claim 9, wherein, in the setting of the margins, the sizes of the margins are decreased as the switched parking mode corresponds to a higher driving skill level.

16. The control method according to claim 9, wherein the parking modes include a beginner mode including at least one level and an expert mode including at least one level.
